(19) United States
(12) Patent Application Publication
(10) Pub. No.: US 2014/0328978 A1
(43) Pub. Date: Nov. 6, 2014

(54) PRESSURE RELEASE CLOSURE DEVICE AND BAG FOR COOKING

(71) Applicant: NESTEC S.A., Vevey (CH)

(72) Inventors: Hiroko Shimada-Kreft, Konstanz (DE); Hock Seng Gordon Soh, Singapore (SG); Cagdas Celik, Singen (DE)

(21) Appl. No.: 14/366,571

(22) PCT Filed: Nov. 30, 2012
(86) PCT No.: PCT/EP12/74178

§ 371 Date: Jun. 18, 2014

(30) Foreign Application Priority Data
Dec. 20, 2011 (EP) 11194703.2

(51) Int. Cl. B65D 33/16; A23L 1/01; A23L 1/22; B65D 63/10; B65D 81/34

(52) U.S. Cl. CPC B65D 33/1616; B65D 63/1027; B65D 81/3461; A23L 1/22; A23L 1/0128; B65D 2563/101; B65D 2581/3437
USPC 426/107; 383/71; 206/231; 426/243

(57) ABSTRACT

The present invention concerns a kit of parts comprising a cooking bag for storing food to be cooked in a microwave oven, the cooking bag having a cooking bag opening, and a pressure release closure device, configured for restricting the cooking bag opening when attaching the pressure release closure device at the exterior of the cooking bag thereby contracting the cooking bag opening so as to establish a steam conduit whereby gas pressure in the cooking bag may be released from the cooking bag during cooking in a microwave oven. Further the present invention relates to a pressure release closure device and a method of preparing food using a pressure release closure device.

### FIELD OF THE INVENTION

The present invention concerns a pressure release closure device for a cooking bag for cooking food in a microwave oven. Also, the present invention concerns a kit of parts comprising a pressure release closure device and a bag for cooking food in a microwave oven. Further, the present invention concerns a method of preparing food in a microwave oven.

### BACKGROUND OF THE INVENTION

When consumers wish to cook food, e.g. chicken or other meat product, in a microwave oven, they may use a cooking tray. This leaves the food exposed for staining the interior of the microwave oven. Due to the nature of the microwave oven there is a risk that the food is unevenly cooked. The food may be a combination of meat and vegetables. A microwave oven heats food by dielectric heating, using microwave radiation to excite polarized molecules within the food. Microwave ovens heat foods quickly and efficiently, compared to other cooking techniques. A microwave oven works by passing non-ionizing microwave radiation, usually at a frequency of 2.45 GHz through the food. Water, fat, and other substances in the food absorb energy from the microwaves in a process called dielectric heating.

Uneven heating in microwaved food can be partly due to the uneven distribution of microwave energy inside the microwave oven, and partly due to the different rates of energy absorption in different parts of the food.

One way of preventing staining when cooking in a microwave oven is to provide a cooking container with a lid having a manually actuated valve in the lid. This, however, is costly as producing the container then requires large number of production steps and a large amount of material, e.g. cutting a hole in the lid, providing the valve, placing the valve and correctly attaching the valve at the hole. All of these steps must be performed carefully with a rise in production cost to follow. Further, there is a risk that the valve and lid may break during cooking. Further, there it is a major disadvantage in that the cooking container and lid assembly is not easy to pack, store and transport.

### SUMMARY OF THE INVENTION

Therefore there is a need for a simple, cheap, easy to store and transport solution that provides a cooking utensil or implement for a consumer to prepare food in a safe and sanitary way.

In a first aspect the present invention concerns a kit of parts comprising a cooking bag for storing a product food to be cooked in a microwave oven, the cooking bag having a cooking bag opening, and a pressure release closure device, configured for restricting the cooking bag opening when attaching the pressure release closure device at the exterior of the cooking bag thereby contracting the cooking bag opening so as to establish a steam conduit whereby gas or steam pressure in the cooking bag may be released from the cooking bag during cooking in a microwave oven.

In a preferred embodiment the pressure release closure is adapted to allow at least the release of steam from a 1000 W microwave oven. The means that 0.45 g of steam per second (or 0.76 I per second at normal pressure) is preferably allowed to be released.

The steam flows out due to overpressure, the size of the hole, opening or conduit required will depends on the overpressure that the cooking bag is able to withstand before exploding.

For the cooking bag it is preferred that the heat sealed sides allow the bag to hold a pressure of above 2 bars.

By supplying a pressure release closure device and a cooking bag together the consumer is ensured that a pressure release closure device and cooking bag match so that a certain conduit size may be established when cooking. Cooking bags for cooking food usually comes in different sizes dependent on the size of food to be cooked. If the consumer was allowed to choose his or her own bag size, e.g. from a shelve in a shop where several cooking bag sizes and several pressure release closure device are available there is a risk that the consumer will choose a too restrictive pressure release closure device relative to cooking bag size, which could cause a too high pressure to be established in the cooking bag when cooking, and thus cause the cooking bag to rupture. Also, by supplying a kit comprising a pressure release closure device and a cooking bag, the consumer is relieved of the task of locating, identifying and collecting several products.

Advantageously the pressure release closure device defines a closure device area and the cooking bag in a relaxed state defines a bag opening area and wherein the ratio between the closure device area and the bag opening area is in the range 1:20 to 1:2, such as in the range 1:15 to 1:2,5, such as in the range 1:10 to 1:4. The ratio determines how much the cooking bag opening is restricted, which again influence how much steam may be released in a given period of time, i.e. the steam release rate. The closure device area relates to the restriction of the cooking bag opening in that a smaller closure device area results in an increased restriction of the cooking bag opening.

Advantageously the barbs of the barbed part may have similar maximum widths, alternatively the barbs of the barbed part have different maximum widths. The determination of selecting barbs having similar widths or not depends on the intended function. Barbs having relatively large widths have a larger retaining strength compared to barbs having a relatively small width compared to the width of the corresponding opening. By having a barbed portion or part where the barbs have different widths different retaining strengths may be established. Also, the force experienced by the pressure release closure device depends on the amount of steam generated in the cooking bag and the extend of the restriction of the cooking bag opening, i.e. size of the conduit.

When having a barbed part having different size barbs the barbs may be arranged so that the maximum width of the barbs decreases as a function of increasing distance from the opening. Alternatively the barbs may be arranged so that the maximum width of the barbs increases as a function of increasing distance from the opening.

Advantageously when the pressure release closure device is configured for restricting the cooking bag opening the pressure release closure device defines a circumference length in the range 2 cm to 20 cm, such as 5 cm to 15 cm, such as 8 cm to 12 cm. The pressure release closure device may include a substantially circular opening for receiving the cooking bag so as to establish the steam conduit.

Advantageously the kit of parts may further comprise a packaging having one compartment for storing the pressure release closure device and the cooking bag. The packaging may then include cooking instructions for the consumer, as well as other information, e.g. serving suggestions.

For reducing storage space the cooking bag may be folded when storing it in the packaging.

Advantageously the pressure release closure device may be made from part of the packaging. This could e.g. be a pre-punched area in the packaging. When preparing food the consumer, after having removed the cooking bag from the packaging, presses the pressure release closure device from a part of the packaging. The shape of the pressure release closure device could be indicated graphically indicating where the consumer is to release the pressure release closure device from the packaging. The pressure release closure device could include a slit for receiving the cooking bag opening, a circular opening for receiving the cooking bag opening, an elliptical opening for receiving the cooking bag opening, a polygonal opening for receiving the cooking bag opening or any other suitably shaped opening for receiving the cooking bag opening.

Advantageously the cooking bag may be made from a layer of PP or PET. The cooking bag advantageously has a thickness in the range 11 μm to 13 μm, such as 12 μm. This is advantageous when using the cooking bag for preparing food in a microwave oven.

Advantageously the cooking bag may have a heat resistance allowing the cooking bag to resist a temperature of more than 220 degrees for a period of not less than 2 hours. This is advantageous when using the cooking bag for cooking the products for the mentioned period of time. It would be greatly disadvantageous if the cooking bag was not able to be in the microwave oven for as long as the product was to be cooked.

Advantageously the pressure release closure device may have an overall length in the range 5 to 12 cm. This allows the pressure release closure device to establish closure device areas in the required sizes for usual sizes or amounts of food products.

When having a pressure release closure device defining a substantially circular geometry, it would be advantageous to establish a closure device area where the diameter is in the range 10 mm to 20 mm, such as 11 mm to 15 mm.

Advantageously the pressure release closure device has a length of about 50 mm from the opening to the end fastening part. This allows a certain minimum closure device area, i.e. a maximum restriction of the cooking bag opening, to be established by the pressure release device.

Advantageously the kit of parts may further comprise a seasoning mix for being applied to the product to be cooked. Thereby the consumer is further relieved of identifying a suitable seasoning to be used when the pressure release closure device and the cooking bag. The seasoning mix may in general be a dry seasoning, or a marinade.

Advantageously the seasoning mix is stored in a seasoning mix bag. Thereby it is ensured that the seasoning mix does not soil, stain or dirty up the cooking bag and/or pressure release closure device.

Advantageously a packaging having two compartments may be supplied, where a first compartment may be used for storing the pressure release closure device and the cooking bag and a second compartment may be used for storing a seasoning mix. This may alleviate the consumer when preparing food. The consumer may then be removed the seasoning from the package and apply it to the food before unpacking the cooking bag.

In a second aspect the present invention concerns a pressure release closure device for a cooking bag for cooking food in a microwave oven comprising a cooking bag opening, the pressure release closure device is configured for restricting the cooking bag opening when attaching the pressure release closure device at the exterior of the cooking bag thereby contracting the cooking bag opening so as to establish a steam conduit whereby gas pressure in the cooking bag may be released from the cooking bag during cooking in a microwave oven.

The pressure release closure device is adapted for being placed near the open end of a cooking bag at the exterior of the cooking bag. The cooking bag may include one, two, three or more sides that are closed, e.g. by heat sealing. The cooking bag is a type suitable for cooking food in a microwave oven. The pressure release closure device allows a consumer to establish a conduit using the opening of the cooking bag. The pressure release closure device restricts the opening in the cooking bag. As discussed above it is advantageous to keep part of the steam generated from the heating of the food inside the cooking bag, but for safety reasons there is a need for a release of steam pressure. By virtue of the pressure release closure device a part of the steam generated in the cooking bag may be released through the established conduit as long as the pressure release closure device is attached at the opening of the cooking bag. Using a cooking bag will prevent staining on the interior of the microwave oven.

The cooking bag is preferably of a simple kind allowing the overall production cost of the product to be kept low, while providing an improved security in the process of cooking.

The pressure release closure device may be operated stepwise or continuously between two states, or two extremes, including a narrow state where the pressure release closure device defines a maximum restriction of the cooking bag opening, and an large state where the pressure release closure device defines a minimum restriction of the cooking bag opening.

A large closure device area, i.e. a smaller restriction of the cooking bag opening, relative to the area of the cooking bag opening allow for a large or high steam level or steam jet to leave the cooking bag.

The consumer may be provided with cooking instructions for preparing selected food products. This could be provided on the packaging supplied with the pressure release closure device, and may include a list of food product sizes and recommended restrictions of the cooking bag opening. The pressure release closure device could include visual indication of the restriction defined by the pressure release closure device in certain states so that the user is aided in applying the pressure release closure device in accordance with the recommended values.

The pressure release closure device may be supplied in a state where the consumer must assemble the pressure release closure device, e.g. by attaching two ends of the pressure release closure device.

Advantageously the pressure release closure device defines a fixed closure device area. This allows the consumer to easily apply the pressure release device without having to adjust the pressure release device. Further a maximum closure device is always established.

The pressure release closure device may be operable between a minimum restriction and a maximum restriction. This allows a consumer to adapt the pressure release device to the specific cooking operation and/or food amount in the cooking bag. Further it may allow the consumer to set the pressure release device in one position so as to establish one restriction, and if this restriction is too small relative to the amount of steam generated, the pressure release device may be forced to expand and thereby increase the conduit without rupturing the bag.

The pressure release closure device may be made from a non-memory material. This allows the consumer to define a shape or geometry using the pressure release device and the pressure release device to retain this geometry during cooking. If pressure increases to a point where not enough steam is released, the force from the steam may alter the shape of the pressure release device.

In an embodiment the pressure release closure device comprises an elongated body having a first end and an opposite second end, wherein the pressure release closure device further comprises: an opening defined at the first end, an end fastening part configured for securing the second end of the elongated body at the opening, and a transition part formed between the opening and the end fastening part, the elongated body being flexible and the end fastening part being configured for being received in the opening so that when the end fastening part is received in the opening the part of the elongated body between the end fastening part and the opening the pressure release closure device is configured for restricting the cooking bag opening.

This allows the consumer to apply the pressure release device to a suitable cooking bag and to establish a steam release conduit using the pressure release device.

For defining a number of different restrictions of cooking bag openings, the end fastening part may comprise a number of barbs for establishing different size closure device areas. Using a specific barb will establish a respective restriction, i.e. a size for the establishment of the conduit.

When in use the barbs may allow the pressure release closure device to expand as a result of increased steam pressure in a cooking bag relative to a threshold for a specific barb. If the pressure from the jet in the steam conduit increases to a point where the force applied to the pressure release closure device so that it is not able to retain it's position, the barb may release and skip to a neighbouring barb so as to establish a new, smaller, restriction of the cooking bag opening.

One advantage of the above features is that they allow the consumer to assemble the pressure release closure device in an easy manner by inserting the second end into the opening. Also, the barbed part will inspire the consumer to realise that this will help the fastening part to be securely fastened in the opening. The size of the barbs relative to the opening may allow for the closure device area to be increased during cooking, e.g. if the pressure in the cooking bag rises above a certain level causing a steam jet out of the conduit to apply a force to the pressure release closure device so that it will snap or jump one or more steps thereby increasing the closure device area.

The transition part helps define a minimum restriction of the cooking bag as the consumer is not able to fasten the pressure release closure device so as to establish a too narrow conduit.

Advantageously the pressure release closure device may be made from PP. PP is a material well suited for a product to be placed in a microwave oven.

The pressure release closure device may have a cross-sectional shape similar to a clip where the cooking bag is received in the opening and a part of the cooking bag is held by a part of the pressure release closure device.

Advantageously the pressure release closure device may be a memory-free device allowing the consumer to position the pressure release closure device at the opening of the cooking bag and the pressure release closure device will then not return to its previous shape.

Advantageously the pressure release closure device may be ring-shaped so that the cooking bag opening may be received in the pressure release closure device.

Advantageously the pressure release closure device may comprise a body having two opposite ends, where at the two ends two mating parts are formed for establishing a connection holding the two ends together to form a receiving part for receiving the open cooking bag end.

In most embodiments a part of the cooking bag opening extends beyond the pressure release closure device which part may be folded back over the pressure release closure device.

In a third aspect the present invention concerns a method for preparing food, the method comprising:
a) providing a piece of food,
b) providing a kit of parts comprising a cooking bag and a pressure release closure device,
c) placing the piece of food in the cooking bag,
d) placing the pressure release closure device at the exterior of the cooking bag at the cooking bag opening so that a controlled steam release conduit is formed,
e) placing the cooking bag with the food in the microwave oven,
f) cooking the food in the microwave oven for a predetermined period of time,
g) removing the cooking bag with the food from the microwave oven.

The method may, e.g., be relayed to the consumer via printed instructions on a packaging or inset note supplied with one or more of the parts mentioned above.

The method may include preparing a piece of poultry, such as a chicken leg, chicken wing, a whole chicken, chicken breast, other like poultry parts from a turkey, a piece of pork, a piece of beef, a piece of or an entire fish or fish produce, one or more vegetables or vegetable pieces or combinations thereof.

The present invention further concerns use of a pressure release closure device when cooking food in a microwave oven. As mentioned above when cooking food in a microwave oven a large amount of steam is generated. This steam helps cook the food evenly, but excessive steam pressure may rupture the cooking bag. Using the pressure release closure device will reduce the risk of rupturing the cooking bag significantly while improving cooking in a microwave oven.

### BRIEF DESCRIPTION OF THE DRAWINGS

Additional features and advantages of the present invention are described in, and will be apparent from, the description of the presently preferred embodiments which are set out below with reference to the drawings in which:

FIGS. 1-9 are schematic illustrations of pressure release closure devices, and

FIG. 10 11 is a schematic illustration of a packaging including a closure device and a cooking bag.

### DETAILED DESCRIPTION OF THE INVENTION

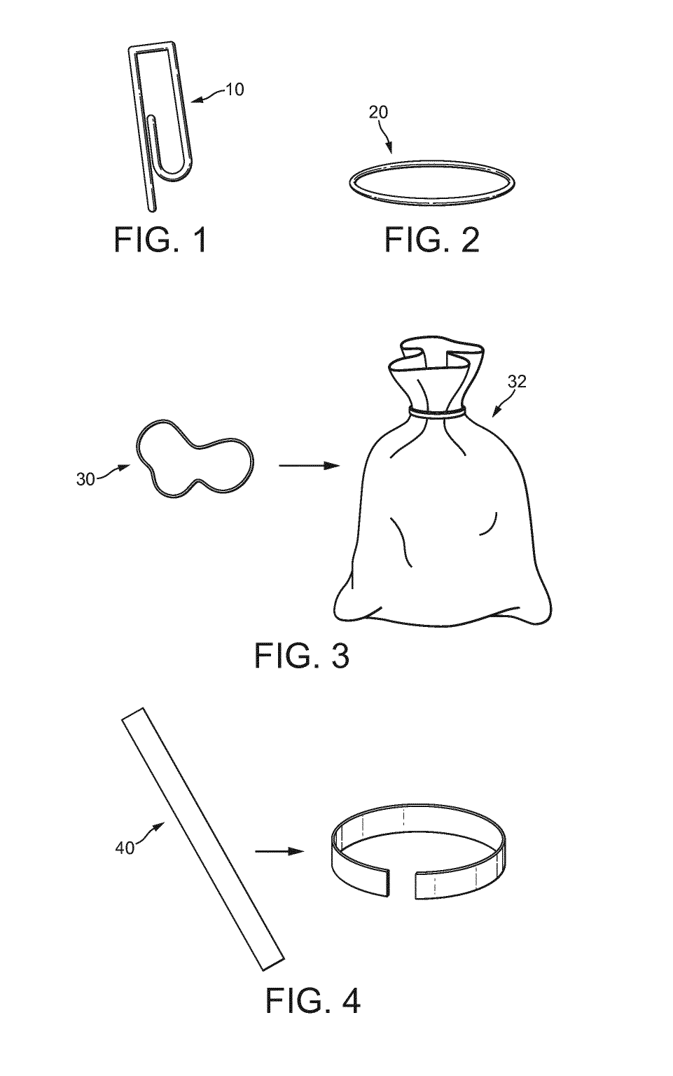

FIGS. 1 to 9 all illustrates pressure release closure devices for use with a cooking bag when cooking food in a microwave oven. The cooking bag used comprises a cooking bag opening. The pressure release closure devices are configured for restricting the cooking bag opening when being attached to the cooking bag at the exterior of the cooking bag the pressure release closure device thereby contracts the cooking bag opening so as to establish a steam conduit whereby steam pressure in the cooking bag may be released from the cooking bag during cooking in a microwave oven

FIG. 1 schematically illustrates an embodiment of a pressure release closure device 10. The pressure release closure device 10 has a cross-sectional geometry resembling a paper clip. The consumer using the pressure release closure device 10 takes a cooking bag having a cooking bag opening and places the cooking bag opening in the pressure release closure device 10. This geometric configuration will have an improved ergonomic form allowing the consumer to easily place the pressure release closure device 10 at the cooking bag.

FIG. 2 schematically illustrates a pressure release closure device 20 in a ring form. The consumer inserts the cooking bag opening through the ring and then folds back the cooking bag around the pressure release closure device 20. The pressure release closure device 20 is rigid which does not allow the pressure release closure device 20 to expand.

FIG. 3 schematically illustrates a pressure release closure device 30. The pressure release closure device 30 is elastic, so that the pressure release closure device 30 may expand to a certain degree. The right hand side of FIG. 3 illustrates the pressure release closure device 30 placed at the opening of a cooking bag 32. The consumer inserts the cooking bag 30 opening through the pressure release closure device 30 and then folds back the cooking bag around the pressure release closure device 30.

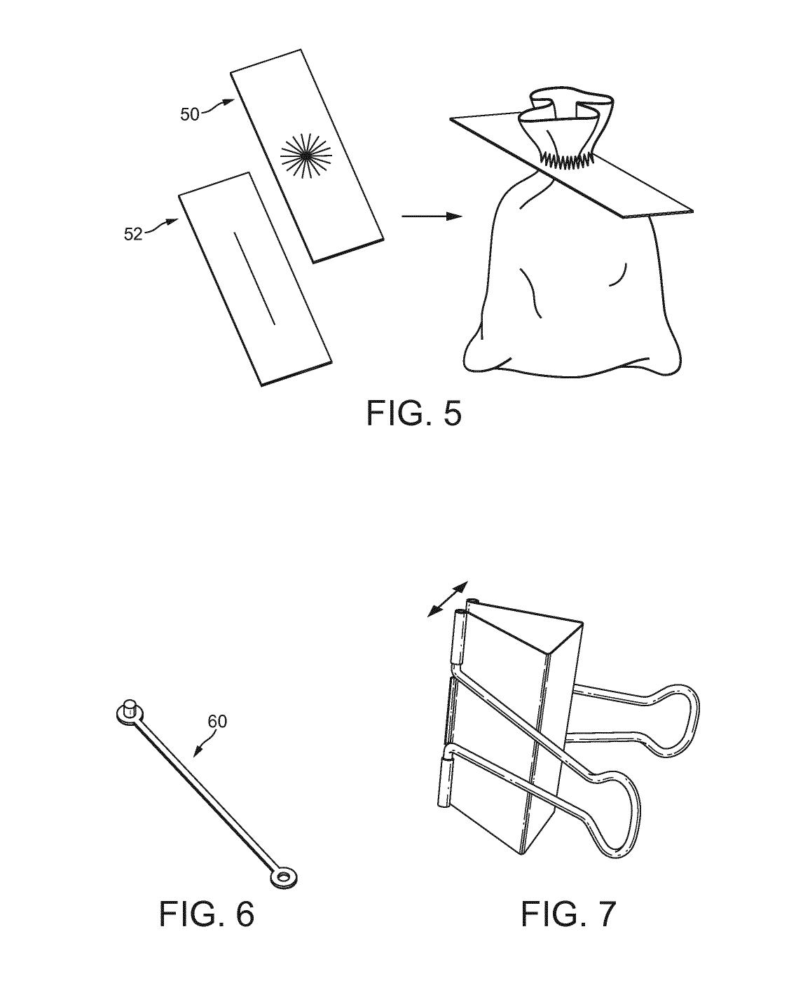

FIG. 4 schematically illustrates a pressure release closure device 40. The pressure release closure device 40 is here a plastic strip with no memory, which means that the plastic strip may be bended and stays in the altered geometry.

FIG. 5 schematically illustrates two pressure release closure devices 50 and 52. The pressure release closure device is made out of the outer box that the cooking bag was supplied in. Alternatively the pressure release closure device 50 and 52 may be supplied to a consumer as a piece of cardboard where the pressure release closure device is pre-cut or pre-punched allowing the consumer to disengage the pressure release closure device from the cardboard carrier. Being pre-cut, it is made easy for the consumer to remove it and slide the cooking bag into it.

FIG. 6 schematically illustrates a pressure release closure device 60. The pressure release closure device 60 has a body having two ends. Both ends are formed so as to allow the end to be “clipped’ into each other.

FIG. 7 schematically illustrates a pressure release closure device in a shape resembling a clip. The consumer squeezes the handles to open the clip. The cooking bag is inserted into the clip and the consumer then releases the handles.

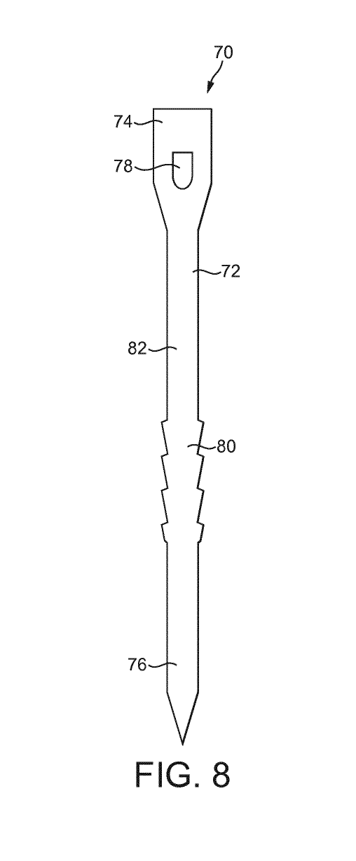

FIG. 8 schematically illustrates a pressure release closure device 70. The pressure release closure device 70 comprises an elongated body 72 having a first end 74 and an opposite second end 76. An opening 78 is defined at the first end 74. The pressure release closure device comprises an end fastening part configured for securing the second end of the elongated body at the opening, here in the form of a barbed part 80 including a number of barbs defined at two opposing side parts of the body 72 at the second end 76. The barbs are distributed over a length of the body 72, namely the barbed part 80. A transition part 82 is formed between the opening 78 and the end fastening part, in this embodiment the transition part 82 is formed between the opening 78 and the barb closest to the opening 78. The transition part 82 defines two opposed, substantially smooth side parts and substantially smooth front and back surfaces. The elongated body 72 is flexible and the barbs are configured for being received in the opening 78 so that when the barbed part 80 is received in the opening 78 the part, including the transition part 82, of the elongated body 72 between the barb and the opening defines the part where the cooking bag opening is to be received.

The opening 78 has a width of 4 mm. From the top of the opening to the start of the barbed part 80 the length is 49 mm. The barbs have a maximum width of 6 mm and a minimum width of 4 mm. The pressure release closure device 70 has a width of 5 mm at the most of the length of the body 72. The length of each barb is 6 mm.

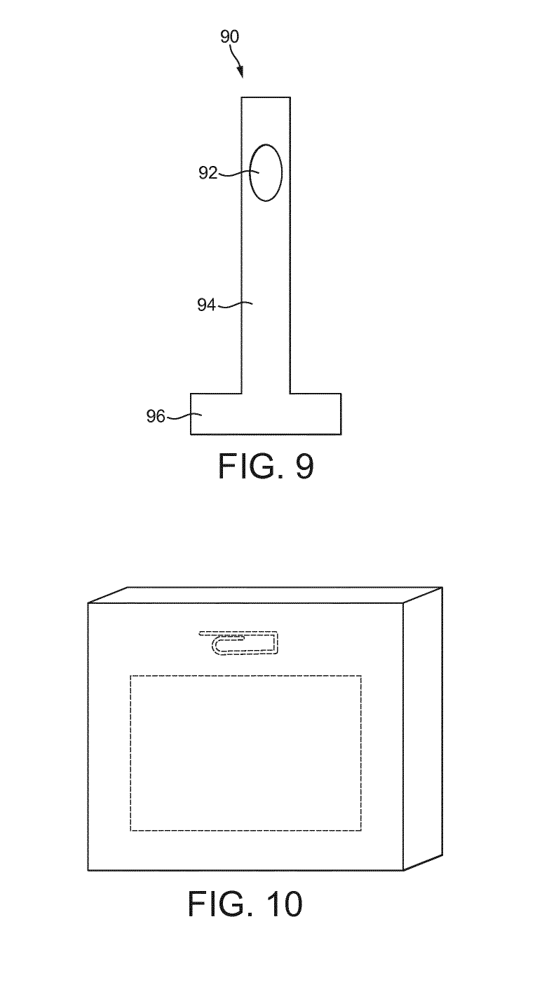

FIG. 9 schematically illustrates a pressure release closing device 90. The pressure release closing device 90 comprises an end having an opening 92. At the opposite end a fastening part 96. When the pressure release closing device 90 is in use, the fastening part 96 is inserted through the opening 92. A transition area or part 94 then defines a closure device area where the open end of a cooking bag may be received.

FIG. 10 schematically illustrates a package comprising a cooking bag and a pressure release closure device. The cooking bag and the pressure release closure device are placed in the same compartment or lumen of the package. This allows a consumer to easily retrieve the package from a self in a store. When preparing food the consumer will have easy access to both a cooking bag and a pressure release closure device at once. In further embodiments a package comprising a cooking bag and a pressure release closure device could be supplied. Here the package comprises two compartments or lumens where one compartment comprises a cooking bag and another compartment comprises a pressure release closure device. This allows a consumer to remove the cooking bag when starting to prepare food. The consumer may then place the food in the cooking bag and subsequently close the opening in the cooking bag using the pressure release closure device, which may be held in the packaging until the consumer needs it.

In still further embodiments a package comprising a cooking bag, a pressure release closure device and seasoning mix could be provided. Here the seasoning mix is stored in a seasoning bag. The seasoning bag is placed in the same compartment as the cooking bag. This allows the user to remove the cooking bag and seasoning for easy preparation of the food before the cooking bag is closed using the pressure release closure device. The seasoning mix may in general be a dry seasoning, or a marinade. Alternatively both a dry seasoning and a marinade may be provided. The marinade may be provided as a dried powder to be dissolved in oil and/or water by the consumer. Alternatively the marinade may be ready to use.

In even further embodiments a package comprising a cooking bag, a pressure release closure device and seasoning could be provided. Here the seasoning is stored in a seasoning bag. The seasoning bag, the cooking bag and the pressure release closure device are placed in separate compartments.

In even still further embodiments a package where a pressure release closure device is obtainable from the packaging could be provided. Here the pressure release closure device is formed from the packaging. The pressure release closure device is defined by a punched or weakened line in the packaging. The consumer presses the pressure release closure device from the packaging. The packaging is made from a material that may be used in a microwave oven.

Lab tests have shown that PET cooking bags closed with a clip with no openings will burst when pressure increases above 5 bars within 5 seconds.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A kit comprising:
a cooking bag for storing food to be cooked in a microwave oven, the cooking bag having a cooking bag opening, and
a pressure release closure device, configured for restricting the cooking bag opening when attaching the pressure release closure device at the exterior of the cooking bag thereby contracting the cooking bag opening so as to establish a steam conduit whereby gas pressure in the cooking bag may be released from the cooking bag during cooking in a microwave oven.

2. The kit according to claim 1, wherein the pressure release closure device defines a closure device area and the cooking bag in a relaxed state defines a bag opening area and the ratio between the closure device area and the bag opening area is from 1:20 to 1:2.

3. The kit according to claim 1, wherein when the pressure release closure device is configured for restricting the cooking bag opening the pressure release closure device defines a circumference length of 2 cm to 20 cm.

4. The kit according to claim 1, comprising a packaging having one compartment for storing the pressure release closure device and the cooking bag.

5. The kit according to claim 4, wherein the pressure release closure device is made from part of the packaging.

6. The kit according to claim 1, wherein the cooking bag is made from PP or PET

7. The kit according to claim 1, comprising a seasoning mix for being applied to the product to be cooked.

8. A pressure release closure device for a cooking bag for cooking food in a microwave oven comprising: a cooking bag opening, the pressure release closure device is configured for restricting the cooking bag opening when attaching the pressure release closure device at the exterior of the cooking bag thereby contracting the cooking bag opening so as to establish a steam conduit whereby gas pressure in the cooking bag may be released from the cooking bag during cooking in a microwave oven.

9. The pressure release closure device according to claim 8, wherein the pressure release closure device define a fixed restriction of the cooking bag opening.

10. The pressure release closure device according to claim 8, wherein the pressure release closure device is operable between a minimum restriction of the cooking bag and a maximum restriction of the cooking bag.

11. The pressure release closure device according to claim 8, wherein the pressure release closure device is made from a non-memory material.

12. The pressure release closure device according to claim 8, where the pressure release closure device comprises an elongated body having a first end and an opposite second end, wherein the pressure release closure device comprises:
an opening defined at the first end;
an end fastening part configured for securing the second end of the elongated body at the opening; and
a transition part formed between the opening and the end fastening part, the elongated body being flexible and the end fastening part being configured for being received in the opening so that when the end fastening part is received in the opening the part of the elongated body between the end fastening part and the opening the pressure release closure device is configured for restricting the cooking bag opening.

13. The pressure release closure device according to claim 12, wherein the end fastening part comprises a number of barbs for establishing different sizes for restriction of the cooking bag.

14. A method for cooking food in a microwave oven comprising using as a pressure release a device comprising a cooking bag for storing food to be cooked in a microwave oven, the cooking bag having a cooking bag opening, and a pressure release closure device, configured for restricting the cooking bag opening when attaching the pressure release closure device at the exterior of the cooking bag thereby contracting the cooking bag opening so as to establish a steam conduit whereby gas pressure in the cooking bag may be released from the cooking bag during cooking in a microwave oven.

15. A method for preparing food, the method comprising:
providing a piece of food;
providing a kit of parts comprising a cooking bag and a pressure release closure device;
placing the piece of food in the cooking bag;
placing the pressure release closure device at the exterior of the cooking bag at the cooking bag opening so that a controlled steam release conduit is formed;
placing the cooking bag with the food in the microwave oven;
cooking the food in the microwave oven for a predetermined period of time; and
removing the cooking bag with the food from the microwave oven.
